(19) United States
(12) Patent Application Publication
(10) Pub. No.: US 2002/0064623 A1
(43) Pub. Date: May 30, 2002

(54) Goal net

(76) Inventor: Brian Vrebosch, Oshawa (CA)

Correspondence Address: BIRCH STEWART KOLASCH & BIRCH, PO BOX 747, FALLS CHURCH, VA, 22040-0747, US

(21) Appl. No.: 09/994,856

(22) Filed: Nov. 28, 2001

(30) Foreign Application Priority Data
Nov. 28, 2000 (CA) 2 327 019

(51) Int. Cl. B32B 3/04

(52) U.S. Cl. 428/122

(57) ABSTRACT

The net has a frame composed of an upright U-shaped member and two braces. The upright member defines the mouth of a goal and the braces maintain the upright member erect. Open mesh is attached to the outer edges of the upright member and the braces. An elongated protective strip is attached over the outer edges in order to cover and protect the mesh where it is attached to the edges. The frame is composed of non-metallic material such as a plastic composite board identified by the trade-mark POLYBOARD.

### BACKGROUND OF THE INVENTION

This invention relates to nets used for goals and more particularly to a net having protective strips for protecting the net from damage which results when a player collides with the net.

Nets commonly used in the games of soccer, hockey, lacrosse, polo and the like are usually made up of a frame composed of tubular steel and an open mesh attached to the frame. In such games, there is a risk that the players will collide with the net and if they do, they may injure themselves. They may also damage the net by causing the mesh to separate from the frame.

### SUMMARY OF THE INVENTION

I have found that a net can be protected from most collisions by providing protective strips in the areas of the open mesh most vulnerable to breakage. In addition, I have found that a frame constructed of a non-metallic material, specifically a plastic composite board sold under the trade mark POLYBOARD is better than a frame constructed of tubular steel. Such material is stronger than the steel generally used in nets yet is flexible and somewhat flexible so that a player who collides with it is less likely to be injured than a player who collides with a frame constructed of tubular steel.

Broadly, the net of my invention comprises a frame having a generally upright U-shaped member which defines a mouth of the goal and at least one brace which maintains the upright member erect. The net has an open mesh which extends from one end of the frame to the other and is fastened to the frame at each of its outer edges. A protective strip is attached to the outer edges and serves to protect the mesh.

### DESCRIPTION OF THE DRAWINGS

Preferred embodiments of the net of the invention are described with reference to the accompanying drawings in which:

FIG. 1 is a perspective view of the net from the front;

FIG. 2 is a perspective view of the net from the rear;

FIG. 3 is an elevation of the net from the side;

FIG. 4 is an elevation of the net from the front;

FIG. 5 is an elevation of the net from the rear, in the absence of a protective strip;

FIG. 6 is an elevation of the net from the rear together with a protective strip; and

FIG. 7 is an elevation of a second embodiment of the net.

Like reference characters refer to like parts throughout the description of the drawings.

### DESCRIPTION OF THE PREFERRED EMBODIMENTS

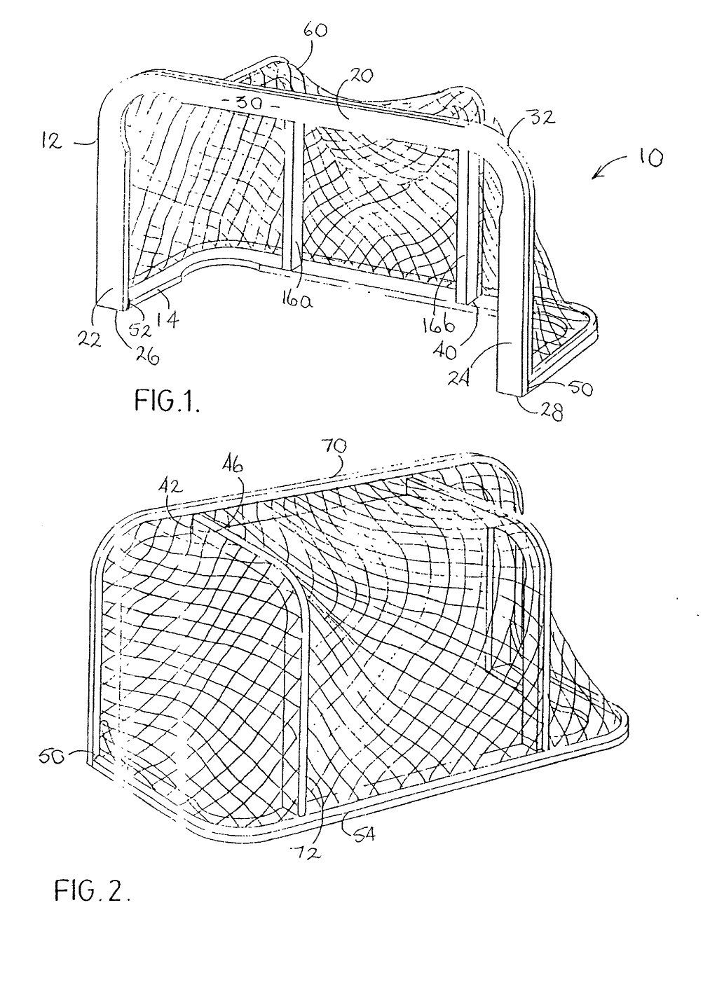

With reference to FIGS. 1 and 2, the net of the invention, generally 10, includes a frame made up of an upright member 12, a base 14 and a pair of braces 16a,b which extend between the upright member and the base.

The upright member defines the mouth of the net into which balls, pucks or whatever else is being played with is intended to be propelled. The member is generally U-shaped and has a horizontal web 20, and a pair of upstanding legs 22, 24 on opposite ends of the web. The legs have bottom walls 26, 28 which rest on the ground. The member has a front face 30 and an outer edge 32 which extends from one bottom wall to the other bottom wall and defines the outer limit of the member.

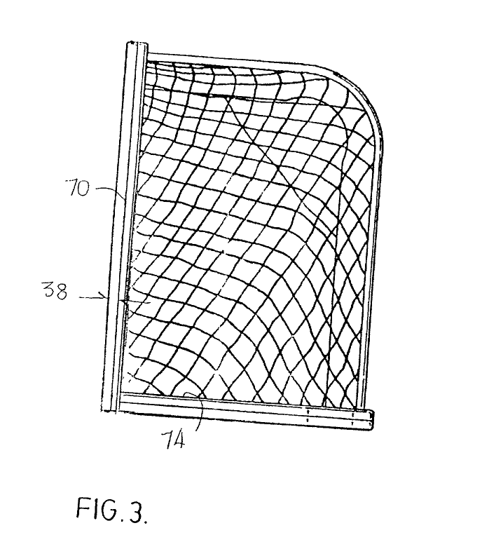

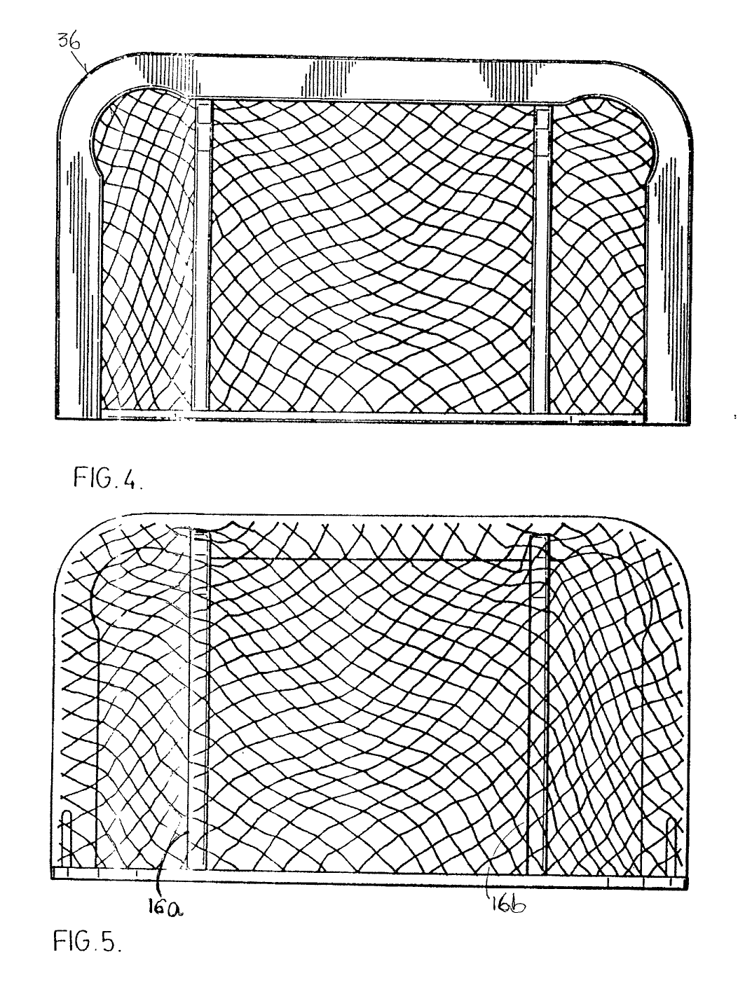

The width of the front face, at its narrowest, indicated 36 in FIG. 4 is preferably at least double the width of the outer edge of the upright, indicated 38 in FIG. 3.

Each brace is generally L-shaped and commences at a lower wall 40 which rests on the base. The brace extends horizontally upward, then vertically inward and terminates at an upper wall 42 which is connected to the rear face 44 of the upright member. The brace has an outer edge 46 which defines the rear limit of the brace.

The base is generally U-shaped and has terminal walls 50, 52 at its ends. An outer edge 54 defines the rear limit of the base. The terminal walls are connected to the legs 22, 24 of the upright member.

An open-meshed fabric 60 of cord, rope, fibre and the like is connected to the outer edges of the upright member, base and the braces. The mesh confines the balls or pucks in the net in the usual manner. Preferably the mesh is attached by staples and less preferably by tacks or nails.

With reference to FIGS. 2 and 3, an elongated length of a protective strip is attached to each outer edge. A first length of protective strip 70 is connected to the outer edge 32 of the upright member, a second length 72 is connected to outer edge 46 of the brace while a third length 74 is connected to outer edge 54 of the base.

The protective strips are preferably pieces of one-half round lengths of non-metallic material. The protective strips are attached to the outer edges of the upright, base and braces by nails or staples so that their flat walls rest upon the outer edges and their rounded walls extend outwardly from the edges.

Each protective strip extends the entire length of the outer edge so that, for example, the first protective strip 70 extends along the entire outer edge of the upright member from one bottom wall 26 to the other 28. Similarly the second protective strip 72 extends from the lower wall 40 to the upper wall 42 of the brace while the third protective strip 74 extends from one terminal wall 50 to the other 52 of the base.

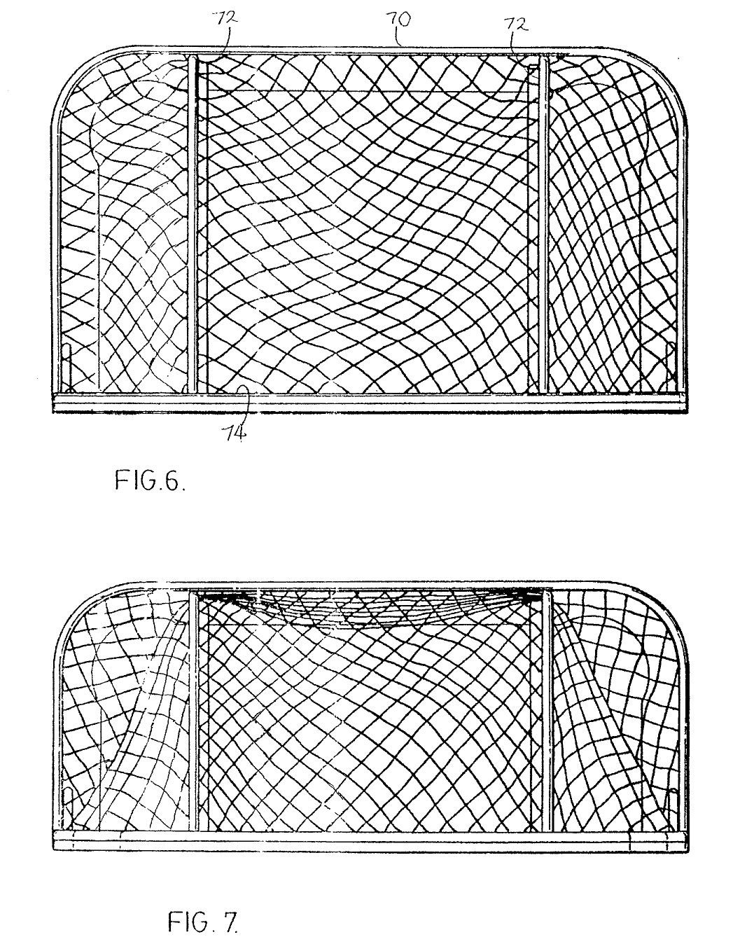

The mesh is attached to the walls in the space between the walls and the protective strips so that the protective strips cover and protect the mesh where it is attached to the edges. In FIG. 5, the mesh is shown covering the outer edges before the protective strips are attached and in FIG. 6, the protective strips are shown attached to the outer edges. The mesh is thus in the space between the outer edges and the protective strips.

The net of the invention may be portable or stationary. It is intended to be light in weight so that it can be moved easily should that be desired. If the net is to be stationary, the base can be made widener so that it can be easily anchored to the ground, to a sheet of ice and so on.

The frame is composed of material which is strong so that it will not break when a player collides with it as is common when it is used in a school-yard or in such games as hockey, lacrosse, soccer, polo and the like. The frame should be relatively resilient and soft so that a player will not be injured if he collides with it. In addition, the frame should be light in weight so that the net can be moved easily. The protective strip likewise is preferably composed of such material.

Preferably, the frame and protective strips are composed of a non-metallic material such as a plastic composite board identified by the trade mark POLYBOARD. The board is sold by Renew Resources Ltd. of Toronto, Ontario, Canada and by New City Resources Inc., NCR Industrial Centre, of Bowmanville, Ontario, Canada.

The net of the invention can have various shapes. In FIGS. 1 to 6 the net is relatively high and short while in FIG. 7 the net is shorter and longer. The mesh is attached more loosely to the frame in the latter Figure while it is more tightly attached in the remaining Figures.

It will be understood of course that modifications can be made in the preferred embodiment of the net described herein without departing from the scope and purview of the invention.

I claim:

1. A net used as a goal comprising: an open-mesh; a frame having a generally upright U-shaped member which defines a mouth of said goal and at least one brace which maintains said upright member erect, said upright member and said brace each having an outer edge; and a protective strip having first and second lengths attached to the outer edges of said upright member and said brace, respectively, said mesh being disposed in the space between said outer edge and said protective strip lengths and being attached to each said outer edge in said space such that said protective strip covers and protects said mesh where it is attached to said outer edges.

2. The net as claimed in claim 1 wherein said frame further includes a generally U-shaped base adapted to lie on the ground, said brace extending between said base and said upright member, said base having an outer edge to which said mesh is attached.

3. The net as claimed in claim 2 wherein a third length of said protective strip is attached to said base.

4. The net as claimed in claim 1 wherein said upright member has a front face which defines the front of said net, said front face being of width at least double of that of the outer edge of said upright member.

5. The net as claimed in claim 1 wherein said upright member has a pair of bottom walls which are adapted to rest on the ground, the outer edge of said upright having a length which extends from one said bottom wall to the other said bottom wall, said first protective strip length being attached to the outer edge of said upright member throughout its entire length.

6. The net as claimed in claim 1 wherein said brace commences at a lower wall and terminates an upper wall which is connected to said upright member, the outer wall of said brace having a length which extends from said lower wall to said upper wall, said second protective strip length being attached to the outer edge of said brace throughout the entire length of said brace.

7. The net as claimed in claim 2 wherein said base has terminal walls at opposite ends thereof, the outer wall of said base having a length which extends from one said terminal wall to the other said terminal wall, said third protective strip length being attached to the outer edge of said base throughout the entire length of said base.

8. The net as claimed in claim 5 wherein said brace commences at a lower wall and terminates an upper wall which is connected to said upright member, the outer wall of said brace having a length which extends from said lower wall to said upper wall, said second protective strip length being attached to the outer edge of said brace throughout the entire length of said brace, said net further being provided with a base having terminal walls at opposite ends thereof, the outer wall of said base having a length which extends from said one said terminal wall to the other said terminal wall, said third protective strip length being attached to the outer edge of said base throughout the entire length of said base.

9. The net as claimed in claim 1 wherein said frame and said protective strip are composed of a non-metallic material

10. The net as claimed in claim 1 wherein said frame and said protective strip are composed of POLYBOARD.
